(19) United States
(12) Patent Application Publication
(10) Pub. No.: US 2006/0204262 A1
(43) Pub. Date: Sep. 14, 2006

(54) Image forming apparatus

(75) Inventor: Masatoshi Hayashida, Kawasaki-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/242,829

(22) Filed: Oct. 5, 2005

(30) Foreign Application Priority Data
Mar. 9, 2005 (JP) 2005-065831

(51) Int. Cl. G03G 15/16

(52) U.S. Cl. 399/66

(57) ABSTRACT

The present invention has been made to provide an image forming apparatus capable of suppressing reverse charging caused by a transfer electric field to thereby suppressing memory image level to a lower level without providing a charge eliminating unit.

In am image forming apparatus according to the present invention, a controller 191 increases and decreases a transfer current from a transfer roller 23 in accordance with the rise and fall of setting values to be set of the background potential of a photoconductor drum 10 and developing bias potential of a developing unit 18. By increasing and decreasing the setting value of the transfer current as described above, it is possible to suppress memory image level (residual image level) that can be caused when the setting values of the background potential of the photoconductor drum 10 and developing bias potential are decreased. In the case where the setting values of the background potential of the photoconductor drum 10 and developing bias potential are set back, the transfer current is also set back, so that it is possible to keep the memory image level at a favorable level.

### BACKGROUND OF THE INVENTION

1. Field of the Invention

The present invention relates to an image forming apparatus and, more particularly, to an image forming apparatus that transfers a toner image formed on a photoconductor onto a printing paper according to an electrophotographic system.

2. Description of the Related Art

When a toner image is transferred from a photoconductor drum onto a printing paper in a conventional image forming apparatus, a reverse charging of the photoconductor drum is caused by a transfer electric field, which may deteriorate memory image level (residual image level). In order to cope with the above problem, a charge on the surface of the photoconductor drum that is being charged to the polarity opposite to the polarity of a developing toner is eliminated after a transfer process. The elimination of a charge is performed after the transfer step but before a cleaning step. For example, as shown in FIGS. 5 and 6, after the transfer step in which a photoconductor drum 110 and a transfer roller 123 are used to perform image transfer onto a printing paper PP, a contact charge eliminating blade 112, a charge eliminating brush or a charge eliminating corona discharger 111 is used for the charge elimination (refer to, for example, Jpn. Pat. Appln. Laid-Open Publication Nos. 6-282144 (pages 3 to 4, FIG. 1), 2000-231234 (pages 3 to 8, FIG. 2), 2003-15371 (pages 3 to 6, FIG. 1), and 2004-286982 (pages 6 to 13, FIG. 4)).

However, the conventional image forming apparatus needs a unit for the charge elimination and a power unit for supplying a power to the unit, making the size of the apparatus main body larger and increasing the number of parts. Further, it is not preferable to adopt the corona discharger because ozone is generated. Furthermore, in the case where the contact-type charge eliminating member is adopted, dielectric breakdown on the surface of the photoconductor drum is generated due to discharge from the distal end of the charge eliminating member, easily causing a defect in image formation.

### SUMMARY OF THE INVENTION

The present invention has been made to solve the above problem and an object thereof is to provide an image forming apparatus capable of suppressing a reverse charging of the photoconductor caused by a transfer electric field to a lower level without providing a unit for eliminating the reverse charging of the photoconductor to thereby prevent deterioration in memory image level caused by the reverse charging.

To solve the above problem, according to an aspect of the present invention, there is provided an image forming apparatus that transfers a toner image formed on a photoconductor onto a printing paper according to an electrophotographic system, comprising a controller that increases and decreases the setting value of a transfer current in accordance with background potential level of the photoconductor.

The controller can increase and decrease the setting value of the transfer current in accordance with the rise and fall of setting values to be set of the background potential of the photoconductor and developing bias potential, so that it is possible to suppress memory image level (residual image level) that can be caused when the setting values of the background potential of the photoconductor and developing bias potential are decreased. In the case where the setting values of the background potential of the photoconductor and developing bias potential are set back, the transfer current is also set back, so that it is possible to keep the memory image level at a favorable level.

In the image forming apparatus having the above configuration, the controller can estimate the background potential level of the photoconductor based on at least one of the setting value of a developing bias potential or that of a charging bias.

In the image forming apparatus having the above configuration, it is preferable that a background potential level detection section that detects the background potential level of the photoconductor be provided and that the controller increase and decrease the setting value of the transfer current in accordance with the background potential level detected by the background potential level detection section.

In the image forming apparatus having the above configuration, it is preferable that the controller perform control of the transfer current at the start-up time of the apparatus or at the time when an instruction is issued from outside of the apparatus. The above transfer current control can be performed as needed at a predetermined interval.

According to another aspect of the present invention, there is provided an image forming apparatus that transfers a toner image formed on a photoconductor onto a printing paper according to an electrophotographic system and performs image quality maintenance control, comprising a controller that increases and decreases the setting value of a transfer current in accordance with background potential level of the photoconductor after the image quality maintenance control.

In the image forming apparatus having the above configuration, it is preferable that the controller estimate the background potential level of the photoconductor based on at least one of the setting value of a developing bias potential or that of a charging bias after the image quality maintenance control.

The image forming apparatus having the above configuration comprises a background potential level detection section that detects the background potential level of the photoconductor, wherein the controller increases and decreases the setting value of the transfer current in accordance with the background potential level after the image quality maintenance control detected by the background potential level detection section.

In the image forming apparatus having the above configuration, the controller performs control of the transfer current at the time when an instruction is issued from outside of the apparatus or immediately after the image quality maintenance control is performed.

As described above in detail, according to the present invention, the controller increases and decreases the setting value of the transfer current in accordance with the rise and fall of setting values to be set of the background potential of a photoconductor and developing bias potential, so that it is possible to suppress memory image level (residual image level) that can be caused when the setting values of the background potential of the photoconductor and developing bias potential are decreased. In the case where the setting values of the background potential of the photoconductor and developing bias potential are set back, the transfer current is also set back, so that it is possible to keep the memory image level at a favorable level.

### BRIEF DESCRIPTION OF THE DRAWINGS

FIG. 1 is a cross-sectional view showing a configuration of the main part of an image forming apparatus according to an embodiment of the present invention;

FIG. 2A is a graph showing the surface potential of a photoconductor drum after a transfer process is performed under predetermined transfer current condition in the photoconductor drum whose surface potential has been set to a predetermined value, and FIG. 2B is a graph showing a relationship between the surface potential of the photoconductor drum and memory image level after the transfer process is performed under the condition as shown in FIG. 2A;

FIG. 3A is a graph showing a change in the memory image level when the surface potential of the photoconductor drum is changed under predetermined transfer current setting condition in the case where process speed is set to 340 mm/sec, and FIG. 3B is a graph showing the surface potential of the photoconductor drum after the transfer process is performed with the surface potential of the photoconductor drum changed under the predetermined transfer current setting condition in the case where process speed is set to 340 mm/sec;

FIG. 4 is a graph showing the memory image level relative to the transfer current for each surface potential of the photoconductor drum based on the result of FIG. 3;

FIG. 5 is a view for explaining a charge eliminating method used in a conventional image forming apparatus; and

FIG. 6 is a view for explaining a charge eliminating method used in a conventional image forming apparatus.

### DETAILED DESCRIPTION OF THE PREFERRED EMBODIMENTS

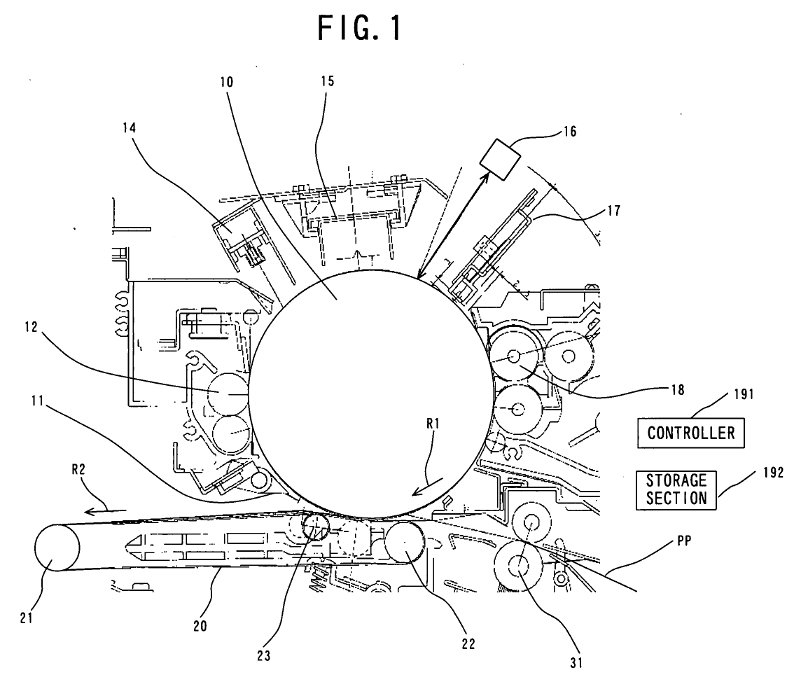

An embodiment of the present invention will be described below with reference to the accompanying drawings. FIG. 1 is a cross-sectional view showing a main part of an image forming apparatus according to the present invention. In the image forming apparatus shown in FIG. 1, a transfer belt 20 is disposed below a photoconductor drum 10 (OPC). The end of a printing paper PP serving as a transfer medium fed by a feeding roller (not shown) is stopped by a resist roller 31, where the printing paper PP is aligned. The aligned printing paper PP is fed to a transfer nip between the photoconductor drum 10 and transfer belt 20 by a roller such as a resist roller according to timing of a transfer process.

The photoconductor drum 10 is supported so as to be rotatable in the direction of the arrow R1. A peeling claw 11, a cleaning unit 12, a charge eliminating lamp 14, a charger 15, an exposure unit 16, a sensor (background potential level detection section) 17, a developing unit 18, and the like are disposed for image formation around the photoconductor drum 10. Further, the image forming apparatus according to the embodiment of the present invention comprises a controller 191 constituted by a CPU and the like for executing various processes in the apparatus and a storage section 192 constituted by a RAM or ROM.

In the processes performed by the above components, a toner image is developed (reverse-developed) on the photosensitive surface of the photoconductor drum 10, and the developed toner image is moved to the position that faces the transfer belt 20 followed by transfer onto the printing paper PP. After the transfer process, the photoconductor drum 10 is subjected to a cleaning process or developing process followed by transfer process again. The controller 191 in the present embodiment has a function of increasing and decreasing the setting value of a transfer current that is applied to the transfer roller 23 in accordance with the background potential level (including background potential level after image maintenance control) of the photoconductor drum 10.

The transfer belt 20 extends between a drive roller 21 and a driven roller 22. In this case, a metal roller 23 for supplying transfer voltage (hereinafter, referred to as merely “transfer roller 23”) is disposed at the transfer nip near the driven roller 22. A power supply to the transfer roller 23 is made from a constant current source and a transfer voltage is maintained at a positive polarity voltage (for example, 1 kV to 6 kV). The printing paper PP fed to the transfer nip between the photoconductor drum 10 and transfer belt 20 is moved on the transfer belt in the direction denoted by the arrow R2 while being sandwiched between the photoconductor drum 10 and transfer belt 20.

During the movement on the transfer belt, a toner image developed on the photoconductor drum 10 is transferred onto the printing paper PP. In order to prevent the printing paper PP from being coiled around the photoconductor drum 10 after the transfer process, the peeling claw 11 is disposed. After completion of the transfer process, the printing paper PP that has been removed from the photoconductor drum 10 is further moved to the direction denoted by the arrow R2 and fed to a fixing unit (not shown), where the toner image transferred onto the printing paper is fixed to the printing paper.

In the image forming apparatus according to the embodiment having the above configuration, image quality maintenance control is performed before the start of normal printing operation. A main function of the image quality maintenance control is to improve tonal characteristics of the image. That is, in the image quality maintenance control, patches for density detection are developed on the surface of the photoconductor drum, and the developed patches are detected by a reflection density detection sensor (not shown) that faces the circumferential surface of the photoconductor drum 10. The control related to the tonal characteristics of the image is performed in accordance with the density of the patches that have not been transferred.

In this control, when the density of the patch (solid black patch) is higher than a standard value (target value) (due to high humidity, for example), the surface potential of the photoconductor drum and developing bias potential are made lower (in the example, they are made lower at an equal rate) to reduce an image contrast potential width which is a difference between the residual potential of the exposed area on the photoconductor drum and developing bias potential. On the other hand, when the density of the patch is lower than a standard value (due to low humidity, for example), the surface potential of the photoconductor drum and developing bias potential are made higher to increase the image contrast potential width. In this case, the controller 191 adjusts the bias voltage and the like of the charger and developing unit to thereby set the surface potential of the photoconductor drum and developing bias potential. The values of the surface potential of the photoconductor drum and developing bias potential are changed at an equal rate with a constant potential difference (for example, 100V) being maintained. With the above image quality maintenance control, excellent tonal characteristics can be obtained.

When the transfer process of the above image forming apparatus is performed under a normal (standard) environmental condition (for example, at normal temperature and humidity), standard settings are made, for example, as follows. The rotational speed of the photoconductor surface is set to 410 mm/sec, background potential (white portion after development) in the photoconductor is set to −600 V, residual potential is set to −100 V, developing bias potential is set to −500 V and transfer current is set to 85 μA. Under the above settings, the potential of the photoconductor drum after the transfer process becomes about 0V. That is, the surface of the photoconductor drum 10 is not reverse-charged (positive polarity). If it is reverse-charged, the charge level is low. Therefore, at the subsequent transfer process time, a memory image (residual image of previous transferred image) caused by the reverse charging does not occur, so that adequate printing density can be obtained.

However, under the environmental condition different from the normal ones, for example, under the environmental condition of 70% or more in humidity, the charge amount of the developer used in the developing unit 18 is decreased. The decrease in the charge amount of the developer weakens the force required for the developer to stay in the developing unit 18, allowing the developer to be easily moved to an electrostatic latent image of the photoconductor drum. That is, the development density of the patch becomes higher in the image quality maintenance control, resulting in deterioration in the tonal characteristics of the image. In order to cope with this problem, the image quality maintenance control is applied to decrease the absolute values of the developing bias potential and photoconductor potential so that the development density of the patch becomes lower to thereby bring the density of the printed image close to a standard state as much as possible. As an example of the control performed in order to obtain the tonal characteristics close to a standard state under the above condition (70% humidity), the potential of the photoconductor drum is set to −400 V, the developing bias potential is set to −300 V, and the residual potential is set to −50 V. In the case of this example, the potential of the photoconductor drum and developing bias potential are changed at an equal rate with a constant potential difference of 100 V being maintained. After the image quality maintenance control with the above settings, the tonal characteristics and printing density become substantially equal to those in the standard state.

Although the tonal characteristics and the like can be kept in good condition by the image quality maintenance control as describe above, the characteristics of the memory image are deteriorated if the transfer current is left in the same state as before the image quality maintenance control. Some of the results obtained by examining the characteristics are shown in the following Table 1. In Table 1, V0 represents the potential of the photoconductor drum, the background potential represents the potential of the white portion on the photoconductor drum after a transfer process, and numbers of the memory image level (residual image level) represent judgment of good or bad in a stepwise fashion from 0 to 5 levels. Here, level “0” represents a state where there is no problem with the memory image, and levels up to “1” are acceptable as “no problem”. As can be seen from Table 1, the memory image level is “0” when the white portion potential is +100 V or less.

TABLE 1

| | Transfer | White portion | Memory image |
|---|---|---|---|
| V0 | current (μA) | potential (V) | level |
| −300 | 60 | 74 | 0 |
| −300 | 70 | 114 | 0.5 |
| −300 | 80 | 147 | 2 |
| −300 | 100 | 197 | 4.5 |
| −400 | 70 | 74 | 0 |
| −400 | 80 | 107 | 0.5 |
| −400 | 100 | 157 | 1.5 |
| −600 | 100 | 105 | 0 |

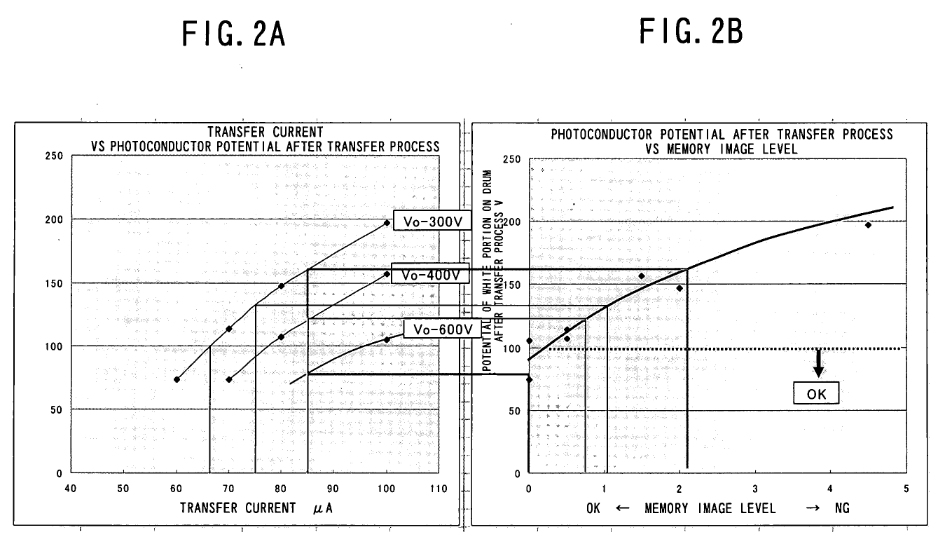

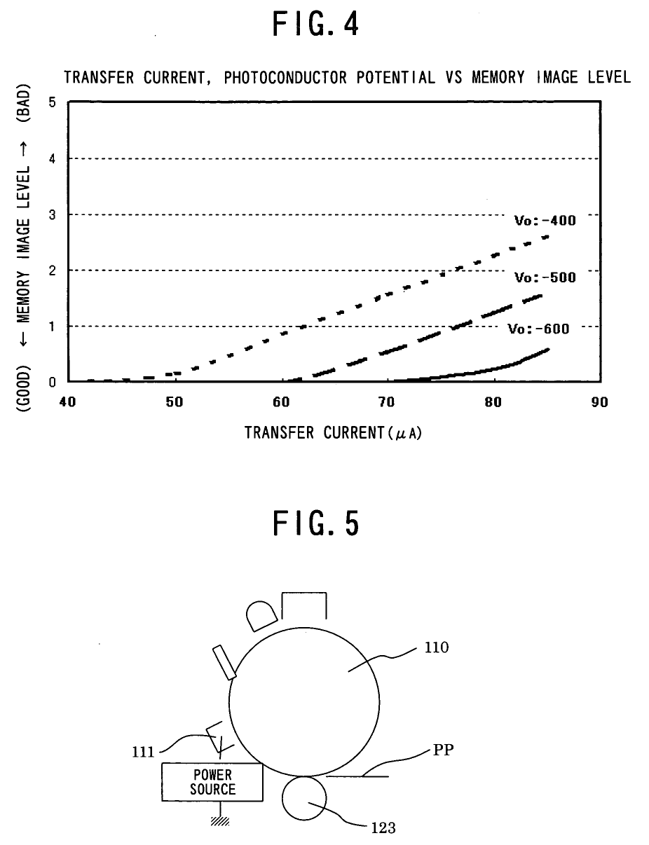

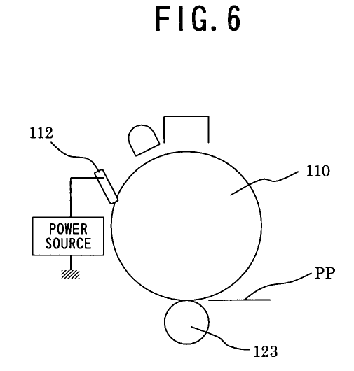

FIGS. 2A and 2B are graphs obtained based on the data shown in Table 1 and the like. As shown in FIG. 2A, in the case where the transfer current is set to 85 μA, the memory image level becomes “0” as shown in FIG. 2B when the potential V0 of the photoconductor drum is −600V, and the memory image level becomes “0.7” when the potential V0 of the photoconductor drum is −400V. Both cases are within acceptable ranges. However, when the potential V0 of the photoconductor drum is −300V, the memory image level becomes “2.1”, which is out of the acceptable range. When referring to FIG. 2A based on “1” of FIG. 2B in order to make the memory image level 1 or less, it can be seen that the transfer current corresponding to “1” of FIG. 2B is 74 μA. That is, in the case where the potential V0 of the photoconductor drum is −300 V, when the transfer current is set to 74 μA, the memory image level can be reduce to “1”. When the transfer current is further reduced from 74 μA, the memory image level becomes less than “1” (for example, it is clear from FIG. 4 that the memory image level becomes “0.3” when the transfer current is 67 μA).

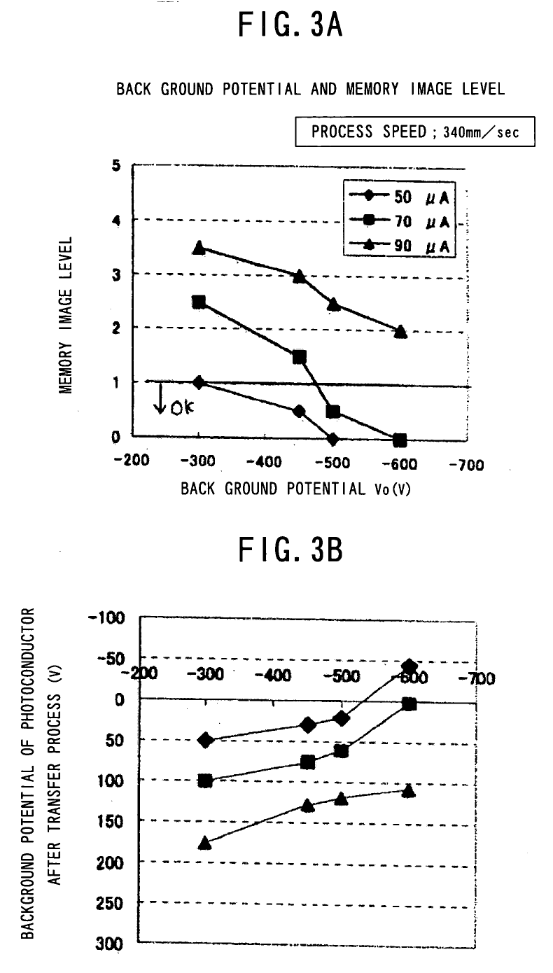

FIGS. 3A and 3B each schematically shows transfer current control performed by the controller 191 based on the above results in the case where the process speed is 340 mm/sec. In FIG. 3, in the case where the surface potential of the photoconductor drum 10 is set to −600 V, when the transfer current is 90 μA (denoted by line A), the surface potential of the photoconductor drum 10 after the transfer process becomes 110 V (FIG. 3B) and memory image level becomes “2” (FIG. 3A). When the transfer current is changed to 70 μA (denoted by line ▴) in order to improve the memory image level, the surface potential of the photoconductor drum 10 after the transfer process becomes substantially 0 V (FIG. 3B), with the result that the memory image level is improved to “0” (FIG. 3A) which is less than the threshold “1”.

Next, the case where the surface potential of the photoconductor drum 10 is set to −450 V will be described. When the transfer current is kept at 70 μA (denoted by line ¦), the memory image level becomes “1.5” (FIG. 3A), which is out of the acceptable range. However, when the transfer current is set to 50 μA, the memory image level becomes “0”, which is acceptable. FIG. 4 is a graph showing the memory image level relative to the transfer current for each surface potential V0 of the photoconductor drum 10 of −400 V, −500 V, and −600 V based on the above result. As can be seen from FIG. 4, in order to keep the memory image level in the acceptable range even when the surface potential V0 of the photoconductor drum 10 is decreased, the transfer current must be decreased according to the graph.

The above correspondence between the background potential level and the transfer current to be set in accordance with the background potential level is previously stored in the storage section 192 as correspondence data. The controller 191 refers to the correspondence data to thereby perform control of the transfer current in accordance with the background potential level.

It is preferable that the abovementioned transfer current control be performed at a predetermined interval. For example, it is preferable to perform the control after the image quality maintenance control at the start-up time of the image forming apparatus, every time the printing is performed for 1000 sheets of papers, or at the time when there is a request from an operator (instruction from outside the apparatus). It goes without saying that it is preferable that the graphs and data used for explaining the above embodiment be stored in the storage section 192 of the image forming apparatus. In this case, the controller 191 reads out the stored graphs or data from the storage section as needed.

The controller 191 can see the surface potential of the photoconductor drum 10 from the setting value of the voltage applied to the charger 15, which has been set by the image quality maintenance control and the developing bias potential from the setting value of the voltage applied to the developing unit 18. This is because that the respective potentials are previously stored in the storage section 192 of the image forming apparatus in association with the voltage setting values. Further, in the case where the difference between these potentials is kept constant as in the above case, when one potential value is apparent, the other potential value becomes inevitably apparent, so that it is only necessary to store one potential value.

As described above, the controller 191 can estimate the background potential level of the photoconductor drum based on at least one of the developing bias potential setting value or charging bias setting value.

Further, it is possible to provide a temperature and humidity sensor and use an eddy-current sensor and the like to directly detect the surface potential of the photoconductor drum 10 without utilizing the potential determined by the image quality maintenance control. More specifically, an adequate surface potential of the photoconductor drum 10 and adequate developing bias potential corresponding to the data detected by the temperature and humidity sensor are stored in the storage section 192 and an adequate transfer current corresponding to the stored surface potential of the photoconductor drum 10 is stored in the storage section. In this case, the controller 191 reads out the surface potential of the photoconductor drum 10 and developing bias potential corresponding to the data detected by the temperature and humidity sensor from the storage section 192 and sets respective potentials according the read out contents.

That is, a sensor (background potential level detection section) 17 is used to detect the background potential level of the photoconductor drum 10 and, in this case, the controller 191 can increase and decrease the setting value of the transfer current in accordance with the background potential level after the image quality maintenance control detected by the sensor 17. As described above, the acquisition method of the information related to the background potential level of the photoconductor drum in the controller 191 can be changed as needed, or depending on the configuration of the apparatus.

What is claimed is:

1. An image forming apparatus that transfers a toner image formed on a photoconductor onto a printing paper according to an electrophotographic system, comprising
a controller that increases and decreases the setting value of a transfer current in accordance with background potential level of the photoconductor.

2. The image forming apparatus according to claim 1, wherein
the controller estimates the background potential level of the photoconductor based on at least one of the setting value of a developing bias potential or that of a charging bias.

3. The image forming apparatus according to claim 1, comprising a background potential level detection section that detects the background potential level of the photoconductor, wherein
the controller increases and decreases the setting value of the transfer current in accordance with the background potential level detected by the background potential level detection section.

4. The image forming apparatus according to claim 1, wherein
the controller performs control of the transfer current at the start-up time of the apparatus or at the time when an instruction is issued from outside of the apparatus.

5. An image forming apparatus that transfers a toner image formed on a photoconductor onto a printing paper according to an electrophotographic system and performs image quality maintenance control, comprising
a controller that increases and decreases the setting value of a transfer current in accordance with background potential level of the photoconductor after the image quality maintenance control.

6. The image forming apparatus according to claim 5, wherein
the controller estimates the background potential level of the photoconductor based on at least one of the setting value of a developing bias potential or that of a charging bias after the image quality maintenance control.

7. The image forming apparatus according to claim 5, comprising a background potential level detection section that detects the background potential level of the photoconductor, wherein
the controller increases and decreases the setting value of the transfer current in accordance with the background potential level after the image quality maintenance control detected by the background potential level detection section.

8. The image forming apparatus according to claim 5, wherein
the controller performs control of the transfer current at the time when an instruction is issued from outside of the apparatus or immediately after the image quality maintenance control is performed.
